(19) United States
(12) Patent Application Publication
(10) Pub. No.: US 2002/0107896 A1
(43) Pub. Date: Aug. 8, 2002

(54) Patent application drafting assistance tool

(76) Inventor: Abraham Ronai, Glen Oaks, NY (US)

Correspondence Address: Abraham Ronai, 253-16 80th Ave., Glen Oaks, NY, 11004, US

(21) Appl. No.: 10/045,915

(22) Filed: Jan. 14, 2002

Related U.S. Application Data
(60) Provisional application No. 60/265,711, filed on Feb. 2, 2001.
(60) Provisional application No. 60/274,707, filed on Mar. 12, 2001.

(51) Int. Cl. G06F 17/24; G06F 17/21

(52) U.S. Cl. 707/530

(57) ABSTRACT

A computer program comprising a number of tools to assist a patent attorney or agent in drafting a patent application.

### CROSS-REFERENCE TO RELATED APPLICATIONS

This application claims the benefit of and herein incorporates by reference provisional application serial Nos. 60/265,711, filed on Feb. 2, 2001, and 60/274,707, filed on Mar. 9, 2001.

### BACKGROUND OF THE INVENTION

1. Field of the Invention

The invention relates to a patent application drafting assistance tool. More particularly, the invention relates to a program or macro for use with a word processor to assist a patent attorney or patent agent in the drafting of a patent application.

2. Description of the Prior Art

A patent application is a legal document describing an invention and detailing the scope of monopoly granted to an inventor by the government in exchange for the public disclosure of his or her invention. A patent application generally comprises a background and summary of the invention, a specification, claims, and an abstract. The background and summary of the invention describe the invention and compare the invention to existing devices. Attention is focused on describing features of the invention that overcome problems with prior art devices. In the specification, the invention is described in fine detail often referring to figures of the invention. Each illustrated part of the invention is assigned a unique reference number which accompanies each recitation of the part, for identification purposes, throughout the specification. The word “a” is used to introduce a part for the first time, after which the word “the” is used. The claims comprise numbered paragraphs, each paragraph containing a description of the monopoly sought. Generally, the shorter and the broader the language used in the claim, the broader the monopoly sought.

In drafting the specification, the drafter often has to retype over and over the part name and its corresponding reference number. The drafter has to scroll back in the document to remember the exact wording or spelling of the part name and also to remember the part number. Needless to say, this process slows down the patent application drafting process. Accordingly, the need exists for a tool to facilitate the drafting process.

The Patent Office examines the patent application for formal requirements and also reviews the claims to assure utility, novelty, and nonobviousness. The patent drafter often has to amend the patent application in response to a rejection issued by the patent office examiner. Generating a typical response to a rejection on a word process, after the effective date for the new regulations requiring amendment by paragraph, involves the following steps: opening the patent application, making the appropriate changes to the application while keeping track of the paragraph and/or claim numbers being changed, drafting an amendment containing replacement specification paragraphs or replacement claims, and also marking up a copy of the original application, for the Examiner's reference, to clearly indicate where the changes have been made (additions often underlined and deletions often crossed out). This is a time consuming process which unnecessarily increases a client's bill. Accordingly, the need exists for a tool to assist in the preparation of an amendment to a patent application.

While present word processing programs on the market may be suitable for general use, the standard tools provided by such programs are not as suitable for the purposes of the present invention as disclosed hereafter.

### SUMMARY OF THE INVENTION

Accordingly, it is an object of the invention to produce a patent drafting tool which overcomes all of the above detailed difficulties with the prior art.

The invention is a computer program comprising a number of tools to assist a patent attorney or agent in drafting a patent application, including (a) an autocompletion means for automatically completing parts and reference numbers already used at least once in the application, (b) an amendment drafting means, (c) a title and abstract length checker, (d) a warning means for detecting potential drafting errors and posting useful warnings to patent drafters, and (e) a means for assuring the existence for support of claim terms in the specification.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE PREFERRED EMBODIMENTS

A great deal of tedious work is generally devoted to writing the specification of a patent application, which involves describing each part of an invention and dedicating a reference number to each part illustrated in the figures. When using a word processor program, such as Microsoft Word® or Word Perfect®, the drafter often has to retype the name of a certain part and its corresponding patent number over and over again. Often the name of the part will be long and tedious to retype and the corresponding reference number difficult to remember. As a result, the drafter finds himself scrolling and looking back in the specification to assure that he is typing the part name correctly and using the correct reference number associated with that part. The autocomplete feature of the present invention enhances the efficiency of a patent drafter by autocompleting parts and associated reference numbers already written at least once in the patent specification. The first time the drafter types a part having a new reference number, a recognition means places the part and its reference number into an autocomplete list. After the drafter starts to retype the part name, and types a predetermined number of letters in the name, an autocomplete means automatically finishes typing the name and the reference number. The recognition means and autocomplete means may comprise computer programs, or more specifically, macros capable of working with and manipulating data or text generated by a word processor. Information is communicated to the word processor via an input device such as a keyboard or mouse.

The recognition means scans the document on a continuous basis for any word followed by a space, followed by a whole number without a decimal point, followed by a space. Using an underscore to represent a space, the term “word” to represent any collection of letters, and the symbol “#” to represent any whole number without a decimal point, the recognition means is continuously looking for the following patterns: word_#_ or word_(#)_. As soon as the last space is entered by the drafter after the number, the part followed by the part number, i.e. the word_#, is entered in the autocomplete list. If a drafter types, “A table 10 has four legs 12”, then “table 10” and “legs 14” will be placed in the autocomplete list by the recognition means. In this example, table and legs are both words and a number follows each of these words. Note that “table 10”, for example, would also have been placed in the autocomplete list if the number 10 was surrounded by parenthesis, i.e. table (10), as is often done in foreign patent applications.

The autocomplete means scans each letter as it is being typed and compares these letters to parts added to the autocomplete list by the recognition means. As soon as a predetermined number of letters of a part in the autocomplete list are typed, the autocomplete means automatically finishes typing the part and its reference number. For example, if the sensitivity of the autocomplete means is set to four letters and if the part “catheter 14” is in the autocomplete list, then as soon as the drafter types “cath” the autocomplete means will automatically complete the rest: “catheter 14”. Alternatively, rather than actually completing the text the auto complete means may open a small window or bubble adjacent the cursor with the completed text, i.e. “catheter 14” inside of it. The drafter can opt to replace his or her typed “cath” with “catheter 14” by pressing enter or another convenient button on the keyboard. In either embodiment, if there is more than one part in the autocomplete list starting with “cath” than all of the possibilities may appear in a window or bubble allowing the drafter to select between them with the up/down arrows, or other convenient keys, on the keyboard.

In order to assure that the recognition means only places true parts and their associated reference number in the autocomplete list, certain common situations need to be continuously screened for. For example, if the word is “has”, “are”, “in”, or “comprises”, or “figure”, or “FIG”, or “FIG.”, or is an actual number spelled out, e.g. “forty”, it should not be placed in the autocomplete list. For example, in the clause “there are 6 sides to a cube 12”, cube 12 should definitely be placed in the autocomplete list, however, “are 6”, should not because, although it fits the word_#_ pattern, “are” is not an actual part.

Furthermore, the recognition means should also place into the autocomplete list a word followed by a space followed by a number followed by period, comma, or exclamation mark. This is necessary because a part maybe introduced for the first time, for example, at the end of a sentence. In this situation the number is directly followed by a period. The program should allow for insertion of any part into the autocomplete list so long as the symbol following the number is required for grammar related reasons.

The program also facilitates the situation where the drafter knows the number of the part but does remember the name. This is often the situation given that the drafter may refer to the numbered drawings with ease. In a situation like this the user merely has to type the number and press a designated key, such as F1, and the autocomplete means will insert the part name in front or just to the left of the number typed in by the user. Input of a number followed by triggering of the designated key causes the recognition means to compare the number to all part numbers on the autocomplete list and causes the autocomplete means to insert the part name associated with that number before the number in the word processing document. If there is no associated part name in the autocomplete list the program so indicates by returning a message to the user to that extent.

In a similar vane, the program may be set to autocomplete words having above a threshold number of letters. This is useful for long words. In this case the program will be autocompleting words that are not necessarily followed by reference numbers. For example, assume the user sets the threshold to 8. The first time the user types oligonucleotide the recognition means recognizes this as a word having greater than eight letters and puts it into the autocomplete list. Upon typing the word for the second time, as soon as the user types “oligonuc” the autocomplete means completes the word by replaces “oligonuc” with “oligonucleotide”.

Note that the autocomplete features of the present invention are not limited to use in patent applications. They may be used to speed the drafting of any document on a word processor which requires the repeated typing of parts and associated reference numbers and/or long words.

The recognition means deals with parts having more than one word, i.e. “top surface 12”, in one of two ways—

MANUAL MODE:

If the manual mode is chosen, the user directly controls the number of part words entered into the autocomplete list by controlling the spacing between the last part word and the part number. If the user types two spaces between the word and the number (word_{— —}#) then the recognition means will put two words followed by the reference number in the autocomplete list. For example, if a drafter types, “A person 10 has a first leg( two spaces blank) 12 and a second leg(two spaces blank)14”, then “person 10”, “first leg 12”, and “second leg 14” will automatically be put in the autocomplete list. Note that “(two spaces blank)” denotes two blank spaces created by pressing the spacebar on a keyboard twice and is not part of the above sentence. The drafter controls the number of words preceding the reference number that are put in the autocomplete list by adding spaces and/or predetermined symbols between the word preceding the reference number (“word”) and the reference number (“#”), for each space (“_”) an additional word is added. If the drafter wrote, “A person 10 has a first leg 12 and a second leg 14”, then “person 10”, “leg 12”, and “second leg 14” will be added to the autocomplete list. Note that because there is only one space between “leg” and “12” “leg 12”, not “first leg 12”, is placed in the autocomplete list. The program automatically removes the extraneous spacing entered by the user for the purposes of detailing which words preceding the part number are to be entered in the autocomplete list.

AUTOMATIC MODE:

In the automatic mode, the user does not have to make any effort to identify how many words are to be used to identify a given part. The recognition means learns as the patent application is being written. The first time a multiple worded part, such as “top surface 12”, is typed, the recognition means enters the word preceding the number along with the number, “surface 12”, into the autocomplete list, i.e. the program assumes that “top” is a mere descriptor and does not form part of the part name. The second time the user wants to type “top surface 12”, as soon as “top surf” (assuming the sensitivity is set to four letters) is typed the recognition means automatically completes “surf” to “surface 12” (“top surface 12” is not automatically completed because only “surface 12” was entered into the autocomplete list). The recognition means then compares the word preceding “surface 12” the first time it was typed and the second time it was typed. If the word preceding surface, in this case “top”, was typed before “surface 12” in both incidences, then the recognition means changes the entry “surface 12” to “top surface 12” in the autocomplete list, assuming that because the user has used the word “top” before “surface 12” both the first and second time it was typed the word “top” is not a mere descriptor but rather is an identifier which forms the actual part name. The recognition means then proceeds to the word preceding “top” and repeats the above procedure. The recognition means stops comparing when it reaches a predetermined number of matched words, a period or other punctuation mark, or the following “comparison terminator” words not usually used as a part identifiers: comprising, the, a, an, are, it, or, they, their, following, many, of, that, and said.

Consider the following sentence to analyze the automatic mode comparison described above:

A table 10 having a first top surface 12. Said top surface 12 is porous. Said top surface being coated with glue.

Analysis of Example:

By the end of the first sentence, “table 10” and “surface 12” are entered into the autocomplete list via the recognition means because they fit the recognition model: word_#_. It is not clear yet whether the drafter really intends the second part to be named “surface 12”, “top surface 12”, or “first top surface 12”. As soon as the user types “surf” in the second sentence the autcomplete means autocompletes these letters to “surface 12”. Next the recognition means compares the word preceding surface in the second sentence to the word preceding surface in the first sentence. Given that the preceding words match, i.e. they are both “top”, the recognition means changes the word in the autocomplete list from “surface 12” to “top surface 12”. Next, the recognition means compares the second word preceding surface in the first sentence (“first”) and the second sentence (“said”). Because these words are not the same the recognition means does not change the “top surface 12” autocomplete list entry. Note that the recognition means would terminate the comparison given that that word preceding “top” is “said” which is on a list of comparison terminators listed above. In the third sentence, as soon as “top ” is typed (assuming the program is only looking for a match of three letters) the program autocompletes it to “top surface 12”.

At the option of the user, the program may also post useful warnings to the user or drafter. For example, if the drafter inadvertently uses the same reference number for more than one part, a message indicating that this is improper should be posted. The recognition means may also be set not to accept into the autocomplete list different parts having identical reference numbers.

The recognition means or an independent scanning means should scan each word_#_ combination and when placing a new combination in the autocomplete list assure that the “word” is not preceded by the word “the” which should only precede parts already introduced once in the application. The recognition means should post a warning if it detects such a situation such as: “Warning: Your use of the word “the” preceding a newly introduced part may be objectionable, please review”.

Another feature of the present invention assures compliance with 35 U. S. C. 112 which requires adequate support for the claim language in the specification portion of a patent application. A scanning means checks each word in the claims as it is being typed. It then scans the autocomplete list (or alternatively the entire specification) to make sure that this word has already been used or assigned a reference number. If a part is being recited for the first time in the claims section a message should be posted, such as “Warning: You may not have support for this term in the specification.” The scanning means only scans the words being typed in the claims section of the application. Words typed between “In the claims:” and “Abstract”, or other common headings indicating the beginning and end of the claims section of the patent application, will be recognized as words in the claims.

Another feature of the invention assures compliance with patent regulations imposing length limitations on the title and the abstract of the patent application. A counting means counts the number of words in the title and the abstract and alerts the drafter when he has exceeded a predetermined maximum number of allowed words. The counting means displays a warning to the drafter after the maximum number has been exceeded.

The counting means can identify language in the abstract by looking for the word “abstract” in the application followed by multiple spaces. Typical patent applications have the title “Abstract” of the abstract on a separate line. As the drafter types the abstract, the counting means counts the number of words typed. As soon as the drafter goes above a predetermined maximum a warning message is displayed. Typing of the next typical heading in a patent application, for example “Background”, terminates the counting of the abstract words.

The counting means can identify language in the title, and thus knows when to start counting words, when it detects the word “title” followed by multiple spaces or the word “title” followed by a colon. The counting means continues to count words until the drafter presses the return button. Titles do not generally end with a period. Note that alternate events or landmarks can be used to trigger the start and stop of the counting means. An effort has been made to use language used in standard patent applications to facilitate use of the invention.

Another feature of the present invention comprises a set of tools for drafting patent application amendments. In the past, a patent prosecutor was required to indicate the line and page number of each and every change being implemented in the patent application. Recent changes in the patent law now require that entire paragraphs containing changes be replaced. A numbering means of the present invention numbers each paragraph in the patent application text. This feature can optionally be turned on and off by a drafter. Furthermore, the drafter can decide whether to number each paragraph consecutively or to restart the numbering on each page. An amendment drafting means of the present invention keeps track of which paragraph numbers have been changed by a drafter and then creates a set of instructions for replacement of the amended paragraphs. More specifically, the amendment drafting means of the present invention tracks changes made by a drafter to the original patent application, for example, in response to an office action, and also keeps track of the number of each paragraph being amended and of the addition of totally new paragraphs. The amendment drafting means then creates a document or inserts into an existing document: (a) amended claims with changes shown; (b) amended specification paragraphs with amendments incorporated; (c) amended claims with changes incorporated; and (d) amended specification paragraphs with amendments shown.

If a drafter receives an office action requiring changes in paragraph 3 and 4 of the application the drafter would open up his word processor and activate the amendment drafting means of the present invention either by pressing preset keys, using the mouse to click a button on the screen, or accessing an initiation command via a pull-down menu. A box or window would appear on the screen asking the drafter the file name of the patent application he would like to amend. The amendment drafting means would then open this file (with the “track changes” feature activated, see below). As the drafter makes changes to the application the amendment drafting means keeps track of the paragraph numbers of the paragraphs being changed and also keeps track of the changes being made. Additions are underlined and deletions are bracketed (other means for marking changes are anticipated). Upon completion of the changes the filed is saved under a name different than the original application name, for example, under the name “application post first amendment”. Next, another window appears asking the drafter where he wants the list of amendment instructions placed. Alternatively, this question can be asked in the first window too. Presumably, the drafter will type in the name of his amendment form. The amendment drafter means then pastes amendment instructions in this file: specification amendments preferably pasted after “In the specification” language and claim amendment instructions preferably pasted after “In the claims:” language, generally found in typical amendments. Marked up claim amendments being inserted after the “In the claims” language and specification paragraphs with amendments already incorporated being inserted after the “In the Specification” language. The amendment drafter means pastes the marked up spec paragraphs onto a separate page and the claims with the amendments already incorporated on a separate page.

In the case where a drafter wants to add a totally new paragraph, it is convenient to number the new paragraph using a #-# format. For example, a new paragraph inserted between 15 and 16 is numbered 15-1. This format is more convenient than renumbering all the numbers following 15 in the application. If three paragraphs are added between 15 and 16 then they would be consecutively numbered, 15-1, 15-2, and 15-3. Note that the hyphen can be replace with any other marker. The amendment drafting means keeps track of the insertion of new paragraphs and creates an instruction to add the relevant new paragraph in the amendment file.

It is required by the patent regulations that the patent drafter make clear to the Patent Examiner changes made in the replacement paragraphs. The patent law allows drafters to chose their own method of communication of these changes so long as they clearly point out changes made. Upon activation of the amendment drafting means, a drafter, as indicated above, is asked which file he would like to open. Presumably, he will choose a patent application he would like to amend. The amendment means automatically opens the chosen patent application under a different name, such as “application post first amendment”, activates the track changes feature of Microsoft Word, or an equivalent feature on another word processor, and saves the resulting document as a separate file. The program places portions of this marked up version of the patent application, showing all changes, into the amendment, as indicated above. Microsoft Word, and other word processors, have a track changes feature which, when activated, visually indicates to a user in a real time manner changes made to a document, generally additions are underlined and deletions are crossed out. The amendment drafting means may access this tool to create the “marked up version” discussed above.

Patent applications tend to be long documents. The present invention offers another feature which allows a drafter to jump to different sections in the application. Preferably, the program includes jump buttons bringing a user to the background section, the specification, the claims, and also the abstract with the click of the mouse or a button on the keyboard. Additional buttons or sites may also jump a user to the middle of these sections or other useful locations, including the last word typed. This feature of the invention comprises a jump means which first locates the beginning of the relevant section and then places the cursor at that location. Sections can be located by searching for typical language used to introduce these sections in all patent applications. For example, the claims sections begins with the following language: “I claim” or “I hereby claim” or “What is claimed is:”. The abstract usually begins with the heading: “Abstract”. The summary usually begins with: “Summary of the present invention”. The specification usually begins with “Detailed Description of the preferred embodiments”. This method for locating various parts of the patent application may be used in other features described above, for example in the counting means.

As many apparently widely different embodiments of the present invention can be made without departing from the spirit and scope thereof, it is to be understood that the invention is not limited to the specific embodiments thereof except as defined in the claims.

I hereby claim:

1. An assistance device for assisting the drafting of documents on a word processor including part names and related reference numbers, said word processor having an input device, said assistance device comprising a recognition means and an autocomplete means, said recognition means scans each symbol inputted via the input device and places all words followed by a first space followed by a number into an autocomplete list, said autocomplete means scans each symbol as it is being inputted via the input device and compares these symbols to those in the part names already added to the autocomplete list by the recognition means, as soon as a predetermined number of consecutive symbols of a part name in the autocomplete list are inputted via the input device the autocomplete means automatically finishes typing the part name and its reference number or offers this option to a user.

2. The assistance device as claimed in claim 1 wherein the recognition means places all words followed by a first space followed by a number followed by a second space in the autocomplete list.

3. The assistance device as claimed in claim 1 wherein the recognition means places all words followed by a first space followed by a number followed by a period or a comma in the autocomplete list.

4. The assistance device as claimed in claim 1 wherein prior to automatically finishing the part name and reference number already on the autocomplete list the recognition means in certain circumstances extends the part name by adding one or more identifiers before it, the determination as to whether to add identifiers being based on the history of use said identifiers immediately before part names earlier in the document.

5. The assistance device as claimed in claim 1 wherein prior to automatically finishing a part name and reference number already on the autocomplete list the recognition means extends the part name by adding one or identifier words to it, all identifier words modifying the last occurrence of the part name that are the same as the identifier words preceding the most recent occurrence are added to the part name in the autocomplete list.

6. A method for facilitating the drafting of a document containing part names and reference numbers in a word processor having an input device, said method comprising: (a)placing all part names along with their associated part numbers into an autocomplete list on an on-going basis as they are being inputted into the document via the input device; (c)comparing all symbols inputted via the input device to those in the part names already in the autocomplete list; (d) once a predetermined threshold number of consecutive inputted symbols match those of a part name in the autocomplete list replacing the most recently inputted consecutive symbols with the matching part name and its associated part number from the autocomplete list or offering this as an option to a user.

7. The method as claimed in claim 6 wherein in step (a) all words followed by a space followed by a number or a number in parenthesis are placed into the autocomplete list, upon such placement the word being considered the part name and the number its associated part number.

8. The method as claimed in claim 6 wherein in step (a) all words followed by a space followed by a number followed by a space are placed into the autocomplete list, upon such placement the word being considered the part name and the number its associated part number.

9. The method as claimed in claim 6 wherein in step (a) all words followed by a space followed by a number followed by a comma or period are placed into the autocomplete list, upon such placement the word being considered the part name and the number its associated part number.

10. The method as claimed in claim 6 further comprising extending the part name in the autocomplete list by adding identifier words to it prior to the replacement in step (d), all identifier words modifying the last occurrence of the part name in the document that are the same as the identifier words preceding the most recent occurrence are added to the part name in the autocomplete list.

11. The method as claimed in claim 6 further comprising extending the part name in the autocomplete list by adding identifier words to it prior to the replacement in step (d), if the first word immediately before the last occurrence of the part name in the document is an identifier and is the same as the word immediately before the most recent occurrence of the part name then this word is added to the part name in the autocomplete list and becomes the first word in the part name.

12. The method as claimed in claim 6 further comprising extending the part name in the autocomplete list by adding identifier words to it prior to the replacement in step (d), if the first through x words immediately before the last occurrence of the part name in the document are identifiers and are the same as the first through x words immediately before the most recent occurrence of the part name then these x words are added to the part name in the autocomplete list and becomes the first through x words in the part name.

13. An assistance device for assisting the drafting of documents on a word processor having an input device and a display, said assistance device comprising a recognition means and an autocomplete means, said recognition means scanning each symbol as it is being inputted via the input device and placing all words longer than a predetermined number into an autocomplete list, said autocomplete means scanning each symbol as it is being inputted via the input device and automatically completing via the display or offering the option to automatically complete all partial words inputted that match words in the autocomplete list at least by a predetermined number of letters.

14. A computer program product comprising:
a computer useable medium and computer readable code embodied on said computer useable medium for assisting the drafting of documents on a word processor including part names and related reference numbers, said word processor having an input device,
the computer readable code comprising:
computer readable code devices configured to cause the computer to place all words inputted via the input device that are followed by a first space followed by a number into an autocomplete list, words entered into the autocomplete list are part names and the numbers following them are their associated reference numbers;
computer readable code devices configured to cause the computer to compare all symbols inputted by via the input device to the part names already added to the autocomplete list;
computer readable code devices configured to cause the computer to automatically finish or present a user with an option to automatically finish typing the part name and its reference number as soon as a predetermined number of consecutive symbols of a part name in the autocomplete list are inputted via the input device.
